(19) United States
(12) Patent Application Publication
(10) Pub. No.: US 2016/0309728 A1
(43) Pub. Date: Oct. 27, 2016

(54) GRADING SYSTEM

(71) Applicant: Laitram, L.L.C., Harahan, LA (US)

(72) Inventors: Charles J. Ledet, Metairie, LA (US); Bruce F. Taylor, Kenner, LA (US)

(21) Appl. No.: 15/079,827

(22) Filed: Mar. 24, 2016

Related U.S. Application Data
(60) Provisional application No. 62/150,415, filed on Apr. 21, 2015.

(51) Int. Cl. A22C 29/00; B07C 5/10; B07C 5/32

(52) U.S. Cl. CPC A22C 29/005; B07C 5/32; B07C 5/10

(57) ABSTRACT

A multi-stage grading system and method of grading products. The initial stage comprises a binary grader grading products into a large size and a small size. The small-size products are subsequently graded into a plurality of small-size size grades by a mechanical grader. The large-size products are subsequently separated and graded into a plurality of large-size size grades by a higher precision weight-based grader, such as a vision-based grader or a checkweigher.

### CROSS-REFERENCE TO RELATED APPLICATIONS

This applications claims the priority of U.S. Provisional Patent Application No. 62/150,415, filed Apr. 21, 2015. The disclosure of that application is incorporated into this application by reference.

### BACKGROUND

The invention relates to sizing and grading products.

Mechanical graders are used to size and sort articles into different size grades. Common mechanical graders use rollers that form adjustable sizing gaps between adjacent rollers or between rotating bars and a flat surface. The width of the gaps between adjacent rollers increases along their length from the upper entrance end to the lower exit end of a roller-type grader and decreases from bar to bar from entrance to exit in a bar-type grader. The largest-sized products are sorted off closest to the exit with a roller-type grader and closest to the entrance with a bar-type; the smallest-sized products are sorted off closest to the opposite ends.

Shrimp processors often grade shrimp into many size ranges, for example, 15 size grades. A single bar-type grader would require 14 grading bars to sort shrimp into 15 size grades. Such a bar-type grader would have to be long to accommodate so many grades. What is often done to avoid having to use a single long grader is using two bar-type graders. For example, the large shrimp sorted off by the first grading bar of a first 7-bar grader are conveyed to a second 7-bar grader that further sorts the large shrimp into eight grades. The small shrimp not sorted off the first grader's first grading bar are then sorted into one of seven small grades by the remaining six grading bars of the first grader. Thus, instead of a long 14-bar grader, two shorter 7-bar graders can be used. In this way the shrimp are divided into two equal batches and graded in parallel. A similar parallel approach can be used with roller-type graders.

Mechanical roller-type or bar-type graders are useful because they can handle bulk flows of shrimp. But they are prone to misgrading. One measure of grading quality is the uniformity ratio, defined as the ratio of the total weight of the N largest shrimp in a graded batch to the total weight of the N smallest shrimp in that batch, where N is an integer representing typically up to 10% of the total number of shrimp in the batch. Uniformity ratios for mechanical (whether roller-type or bar-type) graders are relatively high, reducing their utility for precision grading.

Large shrimp typically have a higher price differential from grade to grade. And because larger shrimp each weigh more than smaller shrimp, each misgraded large shrimp makes a bigger difference in price than does a misgraded small shrimp.

Weight-based graders using visioning systems to estimate weight and checkweighers used to measure actual weight are also used to size and grade products. But such precision graders require that the products not be presented in bulk for visioning or weighing. And requiring that products in bulk be separated reduces the throughput compared to that of bulk-flow mechanical graders.

### SUMMARY

One version of a grading system embodying features of the invention comprises a mechanical bulk grader grading products into a plurality of small-size size grades and a large-size size grade. A separator separates the products in the large-size size grade into individual distinguishable products. A precision grader determines the weight of each of the products in the large-sized grade received from the separator and grades each of the products into one of a plurality of large-size grades.

Another version of a grading system comprises an initial grader sorting a bulk flow of products into large-size products and small-size products and a mechanical bulk grader grading a bulk flow of the small-size products received from the initial grader into a plurality of small-size grades. A separator separates the large-size products received from the initial grader into individually distinguishable products. A precision grader determines the weight of each of the large-sized products received from the separator and grades each into one of a plurality of large-size grades.

In another aspect of the invention a method for grading products comprises: (a) sorting a bulk flow of products into a first size range and a second size range in a bulk grader; (b) sorting the products in the second size range into a plurality of second grades in a bulk grader; (c) separating the first size range of products into a flow of individually distinguishable products; (d) determining the weight or a weight-related property of each of the individual products in the first size range; and (e) sorting the individual products in the first size range into a plurality of first grades based on weight or a weight-related property.

### BRIEF DESCRIPTION OF THE DRAWINGS

FIG. 1 is a block diagram of a grading system embodying features of the invention;

FIG. 2 is an isometric view of a mechanical bar-type grader usable in a grading system as in FIG. 1; and

FIG. 3 is a top plan view of a vision-based grader usable in a grading system as in FIG. 1.

### DETAILED DESCRIPTION

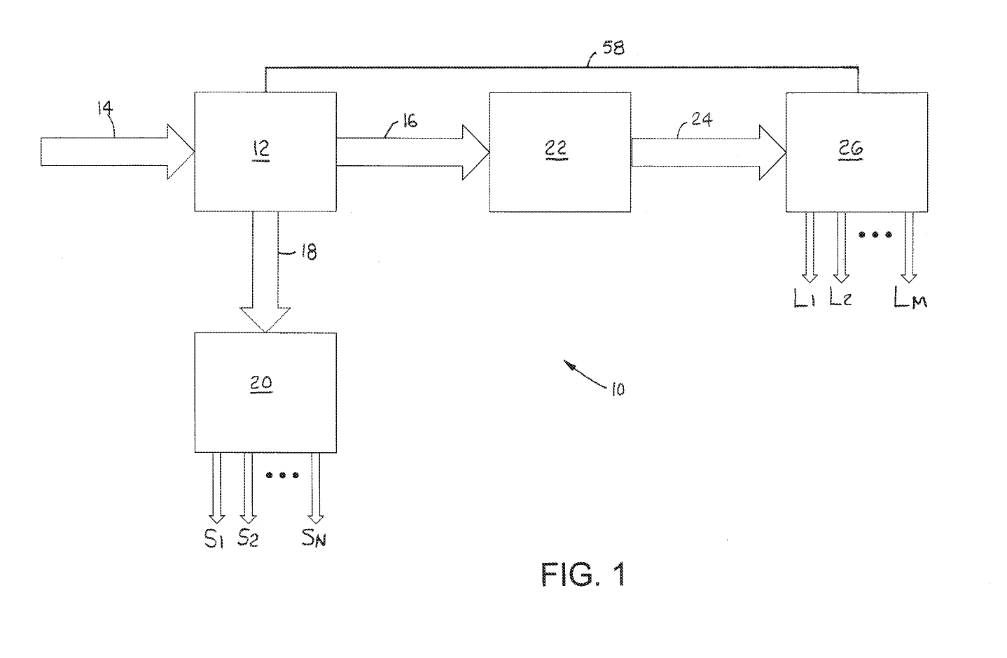

A block diagram of a grading system embodying features of the invention is shown in FIG. 1. The grading system 10 comprises an initial grader 12 that sorts a bulk flow 14 of products into two size ranges of products: large-size products 16 and small-size products 18. The initial grader 12 may be realized as an adjustable roller-type or bar-type grader, or any equivalent mechanical bulk grader that grades products that are received in bulk rather than individually. The demarcation between large and small products may be set to divide the incoming product flow 14 in any ratio, such as one-half. Or the demarcation may be set to sort products above a certain grade to the large size. For purposes of describing the invention, shrimp will be used as an example product.

The mass flow 18 of small shrimp is conveyed to a mechanical grader 20 by a conveyor belt, a flume, or a chute, for example. It is also possible for the initial grader 12 and the mechanical bulk grader 20 to be realized by a single grader. In the case of a single bar-type grader, the grading bar nearest the entrance performs the initial binary grading function by diverting the large-size shrimp 20 in a first initial size range off the grader and passing the small-size shrimp in a second initial size range to the grader's remaining grading rollers or bars. The mechanical bar-type bulk grader 20 then grades the small-size shrimp into N small-size grades S₁-S_{N}. The initial grader 12 could alternatively be realized as a bulk roller-type grader, in which the roller sizing gaps are constant, but adjustable, along the length of the grader. The sizing gap is adjustable to set the desired demarcation between small-size and large-size shrimp. The small-size shrimp falling through the gaps are then routed to a mechanical bulk grader 20 to be graded into the small-size grades S₁-S_{N}. A single roller-type grader with an increasing sizing gap width could also be used to both separate out the larger shrimp and grade the small-size shrimp into individual grades S₁-S_{N}. The remaining shrimp that are not graded into any of the small-size grades S₁-S_{N} are the large-size shrimp. So, instead of exiting the bulk grader first as with the bar-type grader, the large-size shrimp exit the roller-type grader last.

The mass flow 16 of large-size shrimp from the initial grader 12 is conveyed to a separator 22 that separates the shrimp enough for the weight of each shrimp to be determined. The separator 22 may also form the separated shrimp into a single file on a conveyor 24, such as a conveyor belt, conveying the singulated shrimp from the separator. The conveyor 24 feeds the large shrimp to a precision grader 26, such as a weight-based grader. The precision grader 26 may be a checkweigher weighing each shrimp individually or a vision-based grader creating a digital image of each shrimp and from that image estimating the shrimp's weight or a weight-related property of the shrimp, e.g., volume, footprint, or profile, that is functionally related to weight by a predetermined mathematical function. As used in this specification, weight-based grader refers to a grader that is controlled by a system that determines the actual or estimated weight or a weight-related property of individual products. The precision, weight-based grader 26 sorts the separated large shrimp into M grades L₁-L_{M}. The M grades are relatively precise and can be much finer than the grades for the less valuable small shrimp, resulting in the uniformity ratio of the M large-size grades L₁-L_{M} being much closer to unity than the uniformity ratio of the N small-size grades S₁-S_{N}. And because the precision weight-based grader 26 does not have to grade the small shrimp, fewer grading lanes and sorting ejectors have to be used. So the speed of the conveyor belt can be reduced.

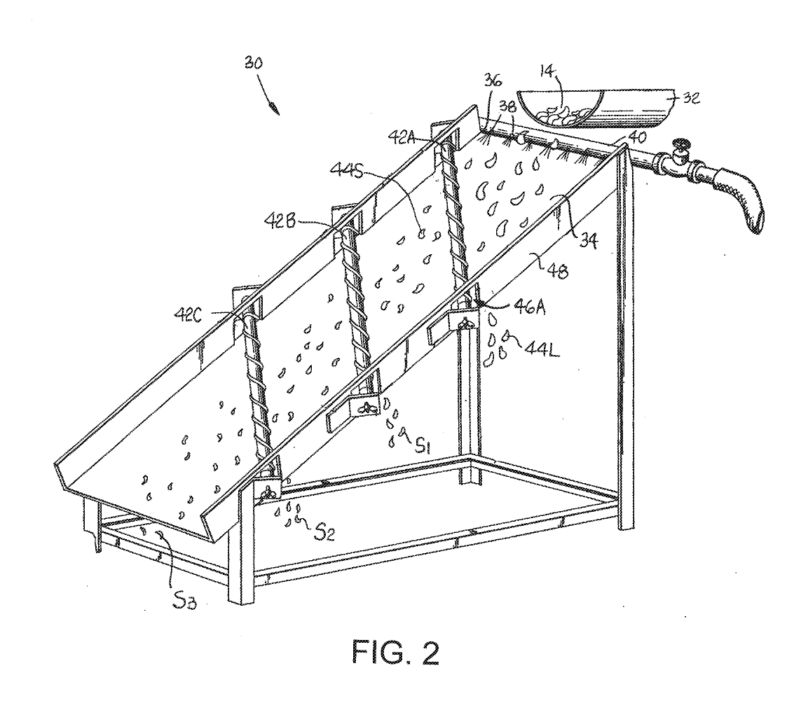

One example of a mechanical bulk grader using three grading bars is shown in FIG. 2. The grader 30 is similar to the Laitram® Model G-8 grader manufactured and sold by Laitram Machinery, Inc. of Harahan, La., U.S.A. (An example of a roller-type grader is the Laitram® Model PRG grader.) The mass flow 14 of shrimp is delivered by a flume 32 to a declining grader bed 34 at its upper end 36. Water issued from nozzles 38 in a conduit 40 lubricates the declining grader bed 34 and, along with gravity, urges the shrimp down the grader. Diagonal grading bars 42A-C, rotated by motors (not shown), are spaced above the bed 34 by a distance defining the grading gaps. The gaps get successively smaller down the grader bed 34. The large shrimp 44L are too large to pass through the gap under the uppermost grading bar 42A. So they are directed by the uppermost roller 42A through an opening 46A in a side wall 48 of the bed 34. The small shrimp 44S pass under the uppermost grading bar 42A to be graded by the remaining two grading bars into successively smaller-size grades S₁-S₃. The shrimp in each small-size grade S₁-S₃ drop into a container (not shown) for each batch. In this arrangement the uppermost grading bar 42A serves as an initial grader sorting the bulk flow of shrimp 14 into large-size shrimp 44L and small-size shrimp 44S.

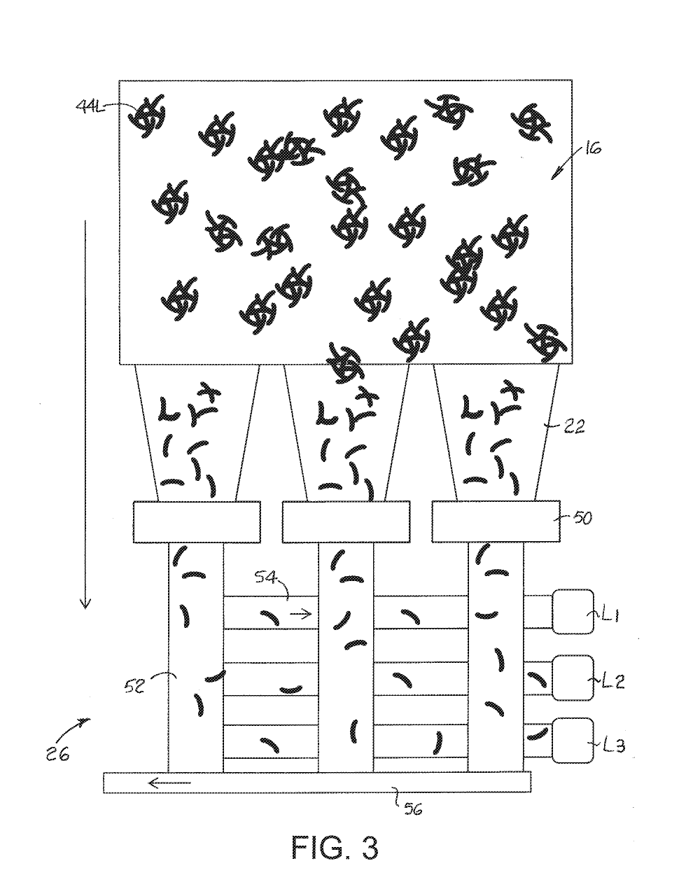

Referring now to FIGS. 1-3, the large-size shrimp 44L are conveyed to the separator 22. The separated large shrimp are conveyed to a vision system 50, which produces a digital image of each shrimp. The vision system 50 estimates the weight of each shrimp from its digital image on a conveyor under the visioning sensor, such as a video camera, ultraviolet sensor, X-ray sensor, or laser sensor. Instead of a vision system the precision grader 26 can use a checkweigher to measure the weight of each shrimp directly. In the case of the checkweigher, the shrimp are presented in a single file so that only one is on the checkweigher at a time. Because the vision system can image more than one shrimp at a time, they don't necessarily have to be in a single file as long as they are separated enough for the vision system to distinguish individual shrimp and produce their digital images. In this example the vision system has three vision stations 50 operating in parallel, but there is no inherent limitation to the number of visioning conveyor lanes 52 or vision systems 50. The shrimp exit the vision stations on the visioning conveyor lanes 52. The vision system 50 controls diverters or ejectors (not shown) to selectively divert each shrimp from the visioning conveyors 52 exiting the vision stations onto transverse conveyors 54, each dedicated to an individual grade L₁-L₃. In this example three transverse conveyor 54 output lanes are used, but there is no inherent limit to the number of these lanes 54. Shrimp and other objects not meeting the grading criteria can also exit onto a reject conveyor 56 for discarding or recirculation back into the input flow 14. Because the precision grader 26 is not overloaded with the small shrimp, the number of conveyors 52 and vision stations 50 that are required may be reduced, as well as the required speed of the conveyors 52

Referring again to FIGS. 1 and 2, the height of the bar 42A performing the initial binary grading function can be adjusted according to various criteria. The initial bar's height can be manually adjusted using methods such as screw-jacks, or the bar can be mechanized and its height remotely adjusted by means such as servo motors. If the bar is remotely adjustable, its height can then be automatically controlled depending on various criteria. For example, a feedback signal 58 to control the initial bar's height can be provided from the vision system or checkweigher to maintain throughput above or below a desirable threshold, which in turn can be automatically adjusted downward to ensure that the uniformity ratio of the vision-graded shrimp does not exceed a maximum acceptable value. Excessive throughput tends to reduce the grading performance of any grading system, whether mechanical, checkweigher-based, or vision-based.

Although the invention has been described mainly with respect to one version, other versions are possible. For example, the initial grader could be a manual operation in which human operators sort the shrimp into large- and small-size grades. And the separator can be realized as a conveyor belt with converging side walls, a flume with a tortuous channel, or a V-channel vibratory feed, for example.

What is claimed is:

1. A grading system comprising:
a mechanical bulk grader grading products into a plurality of small-size size grades and a large-size size grade;
a separator separating the products in the large-size size grade into individual distinguishable products;
a precision grader determining the weight of each of the products in the large-sized grade received from the separator and grading each of the products into one of a plurality of large-size grades.

2. A grading system as in claim 1 wherein the precision grader provides a feedback signal to the mechanical bulk grader to adjust the demarcation between the large-size grade and the small-size grades.

3. A grading system as in claim 1 wherein the precision grader includes a vision system creating a digital image of each of the products in the large-size grade and estimating a weight for each of the products in the large-size grade from the digital image.

4. A grading system as in claim 1 wherein the precision grader includes a checkweigher weighing each of the products in the large-size grade individually.

5. A grading system comprising:
an initial grader sorting a bulk flow of products into large-size products and small-size products;
a mechanical bulk grader grading a bulk flow of the small-size products received from the initial grader into a plurality of small-size grades;
a separator separating the large-size products received from the initial grader into individually distinguishable products;
a precision grader determining the weight of each of the large-sized products received from the separator and grading each into one of a plurality of large-size grades.

6. A grading system as in claim 5 wherein the precision grader includes a vision system creating a digital image of each of the large-sized products and estimating a weight for each of the large-sized products from the digital image.

7. A grading system as in claim 5 wherein the precision grader provides a feedback signal to the initial grader to adjust the demarcation between the large-size products and the small-size products.

8. A grading system as in claim 5 wherein the precision grader includes a checkweigher weighing each of the large-sized products individually.

9. A grading system as in claim 5 wherein the number of large-size grades is different from the number of small-size grades.

10. A grading system as in claim 5 wherein the initial grader is a mechanical bulk grader.

11. A method for grading products, comprising:
(a) sorting a bulk flow of products into a first size range and a second size range in a bulk grader;
(b) sorting the products in the second size range into a plurality of second grades in a bulk grader;
(c) separating the first size range of products into a flow of individually distinguishable products;
(d) determining the weight or a weight-related property of each of the individual products in the first size range;
(e) sorting the individual products in the first size range into a plurality of first grades based on weight or a weight-related property.

12. The method of claim 11 further comprising adjusting the demarcation between the first size range and the second size range.

13. The method of claim 11 comprising:
visioning each of the individual products in the first size range;
creating a digital image of each of the individual products in the first size range; and
determining the weight or weight-related property of each of the individual products in the first size range from the digital image.

14. The method of claim 11 comprising determining the weight of each of the products in the first size range by weighing each product.

15. The method of claim 11 wherein step (b) precedes step (a).

16. The method of claim 11 wherein step (a) precedes step (b).
